(19) United States
(12) Patent Application Publication
(10) Pub. No.: US 2025/0388245 A1
(43) Pub. Date: Dec. 25, 2025

(54) BRAKE MAGNET OF A MAGNETIC RAIL BRAKE DEVICE OF A RAIL VEHICLE

(71) Applicant: KNORR-BREMSE Gesellschaft mit beschränkter Haftung, Moedling (AT)

(72) Inventor: Richard RATHAMMER, Stillfried-Grub (AT)

(21) Appl. No.: 18/917,085

(22) Filed: Oct. 16, 2024

(30) Foreign Application Priority Data
Oct. 16, 2023 (DE) DE102023004180.7

(51) Int. Cl. B61H 7/08; B61H 13/20

(52) U.S. Cl. CPC B61H 7/08; B61H 13/20

(57) ABSTRACT

A brake magnet of an electromagnetic rail brake device of a rail vehicle, the brake magnet including a magnet coil including windings of a conductive coil wire wound about a longitudinal direction of the brake magnet, so that a pass-through opening is formed transversal to the longitudinal direction; a magnet core that includes a yoke that extends through the pass-through opening of the magnet coil and that is enveloped by an upper branch and a lower branch of the magnet coil; and two pole shoes arranged at respective ends of the magnet core and configured to come in friction contact with a rail head of a rail, wherein the magnet core includes two magnet core halves connected with each other and respectively including a yoke part of the yoke, wherein the two magnet core halves protrude into the pass-through opening of the magnet coil.

### RELATED APPLICATIONS

This application claims priority from German patent application DE 10 2023 004 180.7 filed on Oct. 16, 2023, which is incorporated in its entirety by this reference.

### FIELD OF THE INVENTION

The invention relates to a brake magnet of an electromagnetic rail brake device of a rail vehicle according to the preamble of claim 1, a method for producing a brake magnet according to the preamble of claim 9, an electromagnetic rail brake device according to claim 16, and a rail vehicle with the electromagnetic rail brake device according to claim 18.

### BACKGROUND OF THE INVENTION

The brake magnet is a force generating main component of an electromagnetic rail brake device. It is an electromagnet including an electric coil extending in a rail direction and supported by a magnet coil body and a horse shoe shaped magnet core in the prior art. The horse shoe shaped magnet core forms pole shoes at a side oriented towards the vehicle rail. The direct current flowing the magnet coil causes a magnetic voltage that generates a magnetic flux in the magnet core that shortens through the rail head as soon as the brake magnet contacts the rail with its pole shoes. This generates a magnetic attraction force between the brake magnet and the rail. A kinetic energy of the moving rail vehicle pulls the electromagnetic rail brake device along the rail through drive dogs. Thus, the dynamic friction between the brake magnet and rail generates a brake force in combination through the magnetic attraction force. The friction contact with the rail generates friction wear at the pole shoes of the brake magnet, wherein the friction wear must not exceed a maximum wear value.

There are two different basic engineering configurations of electromagnetic rail brake devices.

On the one hand side the electromagnetic rail brake device can be a rigid electromagnetic rail brake device in which the brake magnet is a rigid magnet like e.g. according to U.S. Pat. No. 2,255,798 which includes a box shaped magnet coil body in which a magnet coil is received. The magnet core is configured in plural components, in particular the pole shoes that are in friction contact with the rail are configured as separate components. Rigid magnet electromagnetic rail brake devices are typically used for short distance travel in trams and suburban trains.

Articulated electromagnetic component rail brake devices are known in the art that include articulated magnets configured as the brake magnets in which the electromagnetic coil body includes divider walls and chambers arranged there between. Magnet cores that are movable within limits are supported in the chambers between the divider walls, wherein the magnet cores align during brake operation in order to be able to better follow unevenness at the rail head. In this case the pole shoes are configured at faces of the magnet cores of the intermediary components that are oriented towards the rail. Articulated electromagnetic rail brake devices are typically used in main line trains but are also used in short range traffic in trams and in suburban trains.

A size of a brake force of an electromagnetic rail brake device is a function of a magnetic flux of the magnetic loop, and thus also a function of a geometry of the magnet core or of the magnet cores, the ampere turns and friction conditions between the brake magnet and the rail.

### BRIEF SUMMARY OF THE INVENTION

Thus, it is an object of the invention to provide a brake magnet, in particular a rigid magnet for an electromagnetic rail brake device, in particular for a rigid electromagnetic rail brake device and a method for producing the rigid magnet that facilitates simple separation of its components and simple recycling of its components after reaching its service life or wear limits. Additionally, an electromagnetic rail brake device with this brake magnet and a rail vehicle with this electromagnetic rail brake device shall be provided.

The object is achieved by the independent claims. Additional advantageous variants and improvements of the invention can be derived from the dependent claims.

The inventors have found that a large portion of the electromagnetic rail brake is made from steel and metal alloys. These are in turn connected in with non-metal insulation materials. Separating the materials is difficult economically.

In the prior art like U.S. Pat. No. 2,255,798, the magnet coil is wound up in a magnet coil body, wherein separating the magnet coil from the magnet coil body is only possible by cutting at least one component. Therefore, the brake magnets are typically disposed of in their entirety when repairs are required or at an end of their service life without a recycling concept being available. Automating production of the brake magnet is difficult due to a complex insulation and encapsulation of the magnet coil on the magnet coil body. Last not least side walls arranged in an upper portion of the magnet coil body are not relevant for producing the magnetic field and cause additional material consumption and additional weight.

Thus, it is an object of the invention to be able to separate the components of the brake magnet from each other in a simple manner at an end of the service life of the brake magnet and to render wear parts easily replaceable and re-useable by recycling. The invention provides additional advantages through the fabrication method and by increasing magnetic flux.

A first embodiment of the invention provides a brake magnet, in particular a rigid rake magnet of an electromagnetic rail brake device, in particular a rigid magnet electromagnetic rail brake device of a rail vehicle, the brake magnet comprising:
a) a magnet core including windings of a conductive coil wire wound about a longitudinal direction of the brake magnet, so that a pass-through opening is formed transversal to the longitudinal direction,
b) a magnet core that is in particular horse shoe shaped in cross section and includes a yoke that extends through the pass-through opening of the magnet coil and which is enveloped by an upper arm and a lower arm of the magnet coil, and that includes two pole shoes arranged at respective ends and configured to come in friction contact with a rail.

A generic electric magnet coil is well known and includes windings arranged about a magnet core conducting a magnetic field. These windings are made from an electrically conductive material, in particular metal and configured to conduct electrical current. The electrical current conducted in the windings causes an electromagnetic field to form, which is closed through the horse shoe shaped magnet cores and the rail head.

According to the first embodiment of the invention it is provided that
c) the magnet core includes two magnet core halves connected with each other and respectively including a yoke part, wherein the two magnet core halves protrude into the pass-through opening of the magnet coil, and
d) the magnet coil is configured form stable and/or self-supporting and without a magnet coil body.

Without a magnet coil body means that the brake magnet or the magnet coil are configured without magnet coil body, or that the magnet coil or the brake magnet is configured without magnet coil body. A form stable and/or self-supporting magnet coil is form stable and/or self-supporting by definition and maintains its shape without additional components. Advantageously the magnet coil can contact the magnet core directly without additional components arranged there between.

This generates the following advantages: Since the magnet core and the magnet coil respectively form separate components of the brake magnet, independent repair and recycling of these components is enabled. Thus, the magnet core can be replaced by an overhauled magnet core without having to replace the magnet coil that forms a unit by itself. Since the magnet coil is independent from the magnet core, a low weight can be achieved for the magnet core, while simultaneously increasing magnetic flux density. The geometry of the magnet coil can also be configured symmetrical, e.g. in that the upper branch and the lower branch of the magnet coil are respectively configured with a different height or thickness without having to change the shape of the magnet core. The asymmetrical coil geometry also facilitates a reduction of installed height. Producing an asymmetrical magnet coil therefore is an optional embodiment which provides a high level of flexible with respect to geometry. The self-supporting and form stable magnet coil provides electrical insulation in an optimum manner. A material can be selected for the magnet core that is favorable for the magnet flux. Last not least, the magnet coil and the magnet core can be separated in a simple manner at an end of the service life for recycling.

The magnet core includes two magnet core halves connected with one another respectively including a yoke part that is in particular integrally configured in one piece with the respective magnet core half. The magnet core includes in particular a first magnet core half with a first yoke part and a first pole shoe and a second magnet core half with a second yoke part and a second pole shoe. The two magnet core halves are in particular symmetrical with respect to a central plane of symmetry. Additionally the two magnet core halves contact one another advantageously exclusively with their yoke parts in the plane of symmetry.

In particular the magnet core is made exclusively from the two first and second magnet core halves connected with one another, wherein the first and the second yoke parts and the first and second pole shoes are respectively integrally configured in one piece with the first and second magnet core half. Put differently, the first magnet core half is integrally configured with the first yoke part and the first pole shoe and the second magnet core half is integrally configured with the second yoke part and the second pole shoe. Then, the magnet core is exclusively made from the two magnet core halves that are in particular bolted together and from fasteners connecting the magnet core halves with one another. This configuration facilitates simple assembly and separation of the magnet core halves and the magnet coil since the yoke parts of the two magnet core halves only have to be inserted into the pass through opening of the independently form stable magnet coil and connected with one another for assembly. When the pole shoes respectively form an integral part of the magnet core halves they do not have to be mounted or dismounted separately. When the pole shoes are worn they can be rebuilt by welding on new material onto the arms of the magnet core halves, wherein the material can differ from the material of the magnet core halves. This embodiment is also possible for the new brake magnets.

The configuration of the magnet coil in the brake magnet can be provided as a form stable and/or self-supporting magnet coil without a magnet coil body at least partially in that the windings of the coil wire are connected with one another by an adhesive medium, wherein the medium is advantageously configured electrically non-conductive.

Adhesion means adhesion forces at the contact surfaces between the medium and the coil wire or between different sections of the coil wire through molecular forces. The medium can be in a solid or liquid state. Adhesion for glues means an adhesion of glue layers at the surfaces of the coil wire.

The medium can include at least the following: at least a glue that glues the windings of the coil wire together and/or a curable material wherein the winding of the coil wire are imbedded in or encased by the curable material. In particular the windings of the coil wire can be at least partially encased into a matrix from a resin and/or a synthetic material.

Additionally or alternatively the form stable and/or self-supporting magnet coil without the magnet coil body can be at least partially provided in that the windings of the coil wire are in particular braided together to form a braided material. The magnet coil then forms a braided material made from windings of the coil wire wherein the structure of the braided material can be any structure. The braided material can include twists of the coil wire. The braided material is then advantageously configured so that the magnet coil formed therefrom is form stable or self-supporting.

Additionally or alternatively the form stable and/or self-supporting configuration of the magnet coil without the magnet coil body can be provided at least partially in that at least some of the windings of the magnet coil are windings cast from an electrically conductive coil material and wherein the magnet coil is at least partially configured as a cast magnet coil.

As stated supra regarding advantages provided by the invention, the pole shoes of the magnet coil halves in the brake magnet can be respectively configured integrally in one piece with the respective magnet core half. The integral configuration of the pole shoes with the magnet coil halves reduces magnetic losses since separation gaps lack between the pole shoes and the magnet coil halves and thus increases a magnetic force that presses the brake magnets against the rail.

An additional simplification when producing and mounting the brake magnet can be achieved in that the electrical connections of the magnet coil at the form stable and/or self-supporting magnet coil without a magnet coil body are integrally formed. Put differently, the electrical connections are formed at the magnet coil already during fabrication and form an integral component of the brake magnet together with the magnet coil. Then, no separate connections have to be produced anymore and connected with the windings of the coil wire.

An additional simplification of assembly and disassembly is provided when the magnet coil halves are only connected with one another in that the yoke parts of the magnet coil halves are connected with one another, in particular by a threaded connection through at least one bolt. Then, it is sufficient for assembly or disassembly of the two magnet coil halves at the magnet coil or from the magnet coil to apply the threaded connection or to remove the threaded connection.

A second aspect of the invention relates to a method for producing a brake magnet of an electromagnetic rail brake device of a rail vehicle, the brake magnet including a magnet coil including an electrically conductive coil wire circumferentially arranged about a longitudinal direction of the brake magnet, wherein a pass through opening is configured transversal to the longitudinal direction, a magnet core that is in particular configured with a horse shoe shaped cross section, including yoke which extends through the pass through opening of the magnet core and which is enveloped by an upper arm and a lower arm of the magnet coil, and two pole shoes arranged at ends of the magnet core configured to come into frictional contact with the rail, wherein the magnet core includes two magnet core halves connected with one another and respectively including a yoke part, wherein the magnet core halves protrude into the pass through opening of the magnet coil and are advantageously connected with one another in the pass through opening.

The method includes:
a) producing the magnet coil as a form stable or self-supporting magnet coil without a magnet coil body,
b) producing the two magnet core halves,
c) inserting the two yoke parts of the two magnet core halves into the pass-through opening of the magnet coil, and
d) connecting the two magnet coil halves.

In an advantageous embodiment the method for producing the magnet coil as a form stable and/or self-supporting magnet coil without magnet core body includes
a) winding windings of the coil wire onto a mandrel whose outer contour essentially corresponds to an inner contour of the pass-through opening of the magnet coil, thereafter
b) providing a medium to the windings wound onto the mandrel, wherein the medium connects the windings through adhesion, and
c) removing the mandrel of the shape of the magnet coil after connecting the windings by adhesion.

In particular the windings of the coil wire wound onto the mandrel can be provided with a curable material and/or a glue and the mandrel can be removed out of the pass-through opening of magnet, of the form stable or self-supporting magnet coil after curing the glue and/or the curable material.

According to an advantageous embodiment the method for producing the magnet coil as a form stable and/or self-supporting magnet coil without magnet coil body includes casting the windings of the magnet coil from an electrically conductive coil material and casting the magnet coil, wherein the electrically conductive coil material is heated for casting and solidifies into a predetermined magnet coil shape after the casting.

Alternatively or additionally the method includes producing the embodiment of the magnet coil as a form stable and/or self-supporting magnet coil without magnet coil body may include at least partially braiding the windings of the coil wire with one another to form a structure.

When performing the method connecting the two magnet core halves can be exclusively performed by connecting the two yoke parts, in particular by attaching a threaded connection between the two yoke parts.

As describe supra it is particularly advantageous when the method for producing the form stable and/or self-supporting magnet coil without the magnet coil body includes integral forming of electrical connections at the magnet coil and/or producing the two magnet core halves includes integrally producing the two magnet core halves together with the pole shoes.

A third embodiment of the invention relates to an electromagnetic rail brake device of a rail vehicle, in particular a rigid electromagnetic rail brake device in which the brake magnet is configured as a rigid magnet and which includes at least one brake magnet as described supra.

In the electromagnetic rail brake device the brake magnet can be attached at a lift device which is configured to adjust the brake magnet vertically, to move the brake magnet from a position lifted from the rail into a position lowered onto the rail.

A fourth embodiment of the invention relates to a rail vehicle including the electromagnetic rail brake device described supra.

According to the invention a rail vehicle can include one or plural cars with or without proper propulsion and/or a propulsion vehicle in any combination. In particular the rail vehicle can include motor cars. A rail vehicle or a car of the rail vehicle can include bogies supporting wheel axles of the vehicle. The bogies can be attached at a rail car superstructure. The electromagnetic rail brake device described herein is advantageously supported at a bogie.

### BRIEF DESCRIPTION OF THE DRAWINGS

The invention is now described based on an advantageous embodiment with a reference of drawing figures, wherein:

FIG. 1 illustrates a side view of a rigid magnet of a rigid magnet of an electromagnetic rail brake device according to an advantageous embodiment in an operating position;

FIG. 2 illustrates a perspective view of the rigid brake magnet according to FIG. 1;

FIG. 3 illustrates a face view of the brake magnet of FIG. 1 in the operating position;

FIG. 4 illustrates a cross sectional view along a plane IV-IV of FIG. 1;

FIG. 5 illustrates a perspective view of a form stable and self-supporting magnet coil of the brake magnet of FIG. 1; and

FIG. 6 illustrates a block diagram of a method for producing the brake magnet of FIG. 1.

### DETAILED DESCRIPTION

The drawing figures show an advantageous embodiment of a rigid magnet 1 of an electromagnetic rail brake device configured as a rigid magnet electromagnetic rail brake device. Rigid magnet 1 means that the magnet does not have moveable elements like in an articulated magnet of an articulated magnet rail brake device.

The rigid magnet 1 is attached at a lifting device by a non-illustrated attachment device, wherein the lifting device causes a vertical displacement of the rigid magnet 1 to bring the rigid magnet 1 in contact with a railhead of a rail. The lifting device is in turn attached at a carrier of an axle bearing or at a bogie of the rail vehicle.

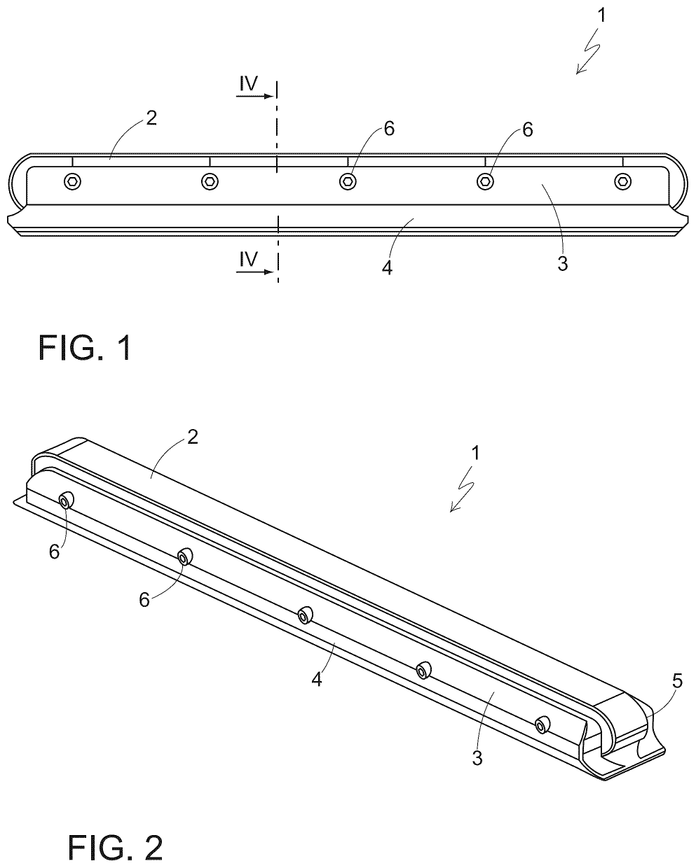

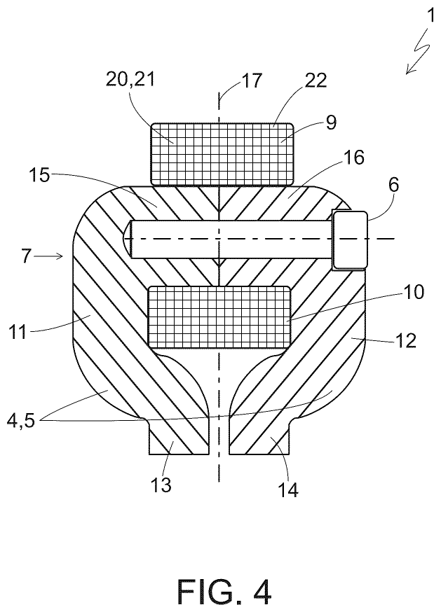

FIG. 1 shows the rigid magnet 1 in a side view and FIG. 2 shows the rigid magnet 1 in a perspective view. The rigid magnet 1 particularly consists of a self-supporting and/or form stable and/or intrinsically stable magnet coil 2 and a magnet core 3 with a two magnet core halfs, a first magnet core half 4 and a second magnet core half 5 (FIG. 4) and fasteners 6 that connect the two magnet core halves 4, 5 with one another.

The magnet coil 2 includes windings of an electrically conductive coil wire circumferentially wound about a longitudinal direction of the rigid magnet 1 wherein a pass through opening 7 is configured in the magnet coil 2 transversal to the longitudinal direction as evident from FIG. 4.

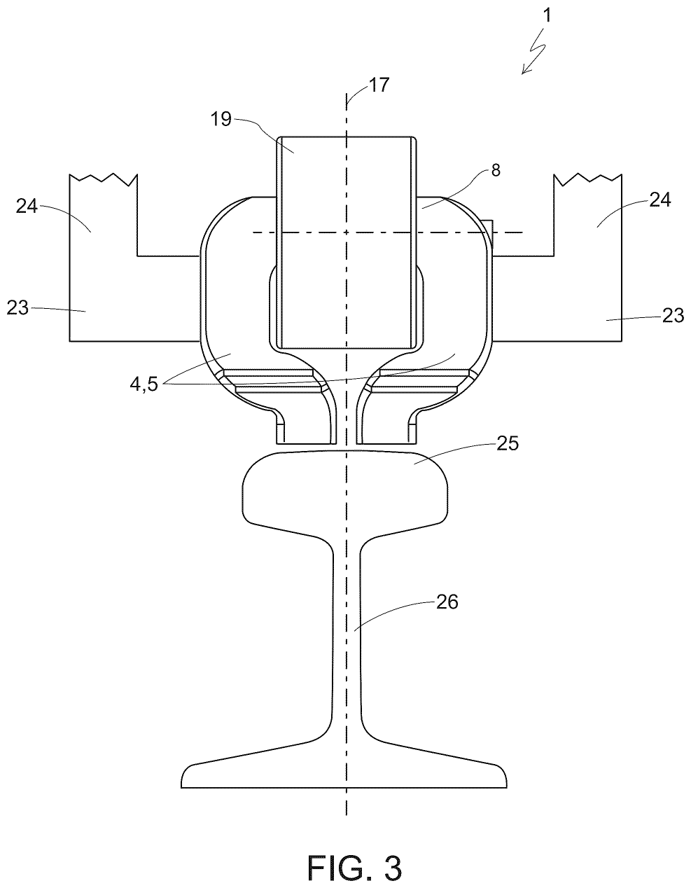

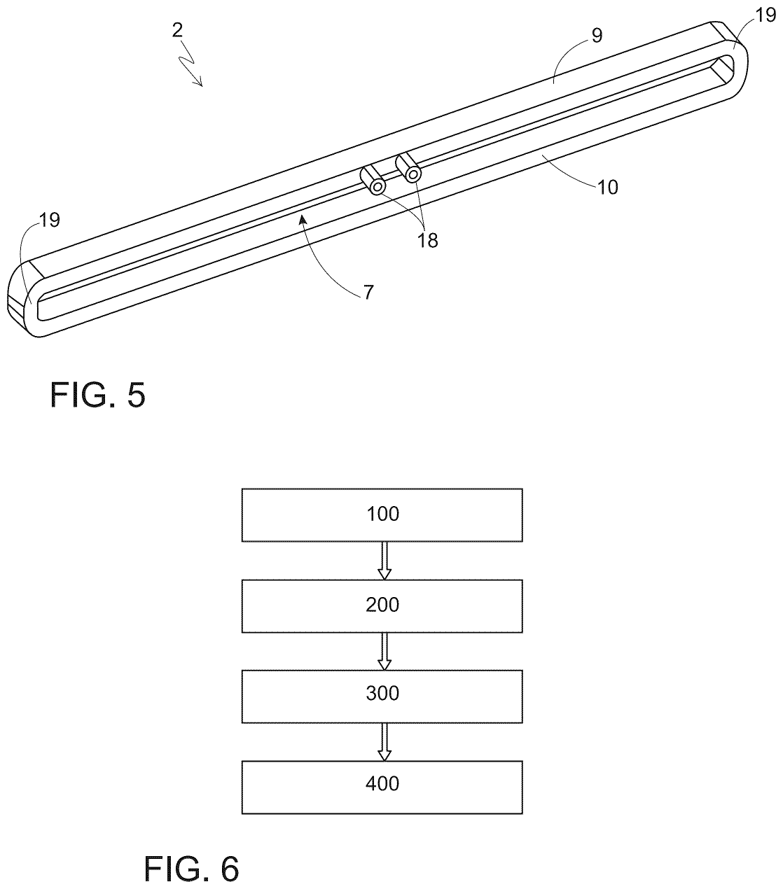

As illustrated in FIGS. 3 and 4 the magnet core 3 is configured horseshoe shaped in cross section and includes a yoke 8 that runs through the pass through opening 7 of the magnet coil 2 and which is enveloped by an upper branch 9 and a lower branch 10 of the magnet coil 2. FIGS. 3 and 5 also show the two transition sections 19 where the upper branch 9 transitions into the lower branch 10 and vice versa. The upper branch 9 and the lower branch 10 and the two end side transition sections 19 then jointly form a closed annular shape that envelopes the yoke 8.

Additionally the magnet core 3 and in particular the two magnet core halves 4, 5 include two arms protruding from the yoke 8 downward, this means towards the railhead in the operating position, namely a first arm 11 and a second arm 12 respectively including pole shoes at their ends, namely a first pole shoe 13 and a second pole shoe 14 which are respectively configured to provide frictional contact with the opposite railhead.

In particular, the magnet core includes the first magnet core half 4 with a first yoke part 15 of the yoke 8, the first arm 11 and the first pole shoe 13, and the second magnet core half 5 with a second yoke part 16 of the yoke 8, the second arm 12 and the second pole shoe 14. Thus, the two magnet core halves 4, 5 includes the first and the second pole shoes 13, 14 at the first and second arms 11, 12 at the first and second yoke parts 15,16 at ends oriented vertically away from each other.

The two magnet core halves 4, 5 are in particular configured symmetrical with reference to a center plane of symmetry 17 of the rigid magnet 1, wherein the center plane of symmetry extends in the longitudinal direction of the rigid magnet 1 and also forms a separation plane between the two yoke parts 15, 16. Additionally the two magnet core halves 4, 5 advantageously exclusively contact at their yoke parts 15, 16 in the plane of symmetry or separation plane 17. The plane of symmetry 17 is vertically oriented in the operating position of the rigid magnet. Thus, the magnet core only consists of the two magnet core halves 4, 5 and the fasteners (bolts 6).

As evident from FIG. 4 the first and the second yoke parts 15, 16 of the two magnet core halves 4, 5 extend into the pass through opening 7 of the magnet coil 2 and are connected in the pass through opening by the fasteners 6, thus e.g. by plural threaded bolts.

The magnet coil 2 is configured without a magnet coil body, this means intrinsically stable and/or form stable and/or self-supporting. Without magnet coil body means that the rigid magnet 1 or the magnet coil 2 are configured without a magnet coil body onto which the magnet coil 2 would be wound. As illustrated in FIG. 5 the magnet coil 2 is form stable or intrinsically stable and/or self-supporting and retains its shape without additional components.

Since the magnet core 3 and the magnet coil 2 are separate components of the rigid magnet 1, independent repair and recycling of these components is enabled.

In the rigid magnet 1 the embodiment of the magnet coil 2 as a form stable and/or self-supporting magnet coil 2 without a magnet coil body can be implemented at least partially in that the windings of the coil wire are adhesively connected with one another by a medium. The medium is advantageously electrically non-conductive.

The medium advantageously includes the following: at least one glue that glues the windings of the coil wire together, and/or a curable material, wherein the windings of the coil wire are embedded into the curable material or incased therewith. In particular the windings of the coil wire can be at least partially embedded into a matrix made from a resin and/or a synthetic material or encased therein. Additionally or alternatively the embodiment of the magnet coil 2 can be implemented as a form stable and/or self-supporting magnet coil 2 without a magnet coil body at least partially in that the windings of the coil wire are braided together to form a braided structure. The magnet coil then represents a braid of windings of the coil wire, wherein the structure of the braid can be any suitable structure. The braid can include twists of the coil wire. The braid is then advantageous configured so that the magnet coil 2 formed therefrom is form stable or intrinsically stable or self-supporting.

Additionally or alternatively the embodiment of the magnet coil 2 as a form stable and/or self-supporting magnet coil 2 without a magnet coil body can be implemented at least partially in that at least some of the windings of the magnet coil are windings cast from an electrically conductive coil material and in that the magnet coil 2 is a magnet coil that is at least partially fabricated by casting.

It is evident that the exemplary features of the embodiment of the magnet coil describe supra as a form stable and/or self-supporting magnet coil 2 without a magnet coil body can be combined with another at will. For example the magnet coil 2 configured as the form stable and/or self-supporting magnet coil 2 without the magnet coil body can be implemented by a combination of a braid of windings of the coil wire with an embedding of the braid in a matrix from an adhesive medium, in particular an embedding of the braid into a curable resin.

As illustrated in FIG. 5 the electrical connections 18 of the magnet coil 2 at the form stable and/or self-supporting magnet coil 2 without the magnet coil body can already be integrally formed during fabrication of the magnet coil 2. Put differently, the electrical connections 18 are already formed during fabrication of the magnet coil 2 and then form an integral one piece component of the brake magnet together with the magnet coil 2.

FIG. 6 shows a block diagram of an advantageous embodiment of a method of producing the rigid magnet 1 of FIGS. 1 through 5.

The magnet coil 2 is fabricated as a form stable and/or self-supporting magnet coil 2 without a magnet coil body as described supra, in particular in the embodiment described supra with respectively integrally formed electrical connections 18 in a single step 100. The result of the step 100 is then illustrated in FIG. 5.

An additional step 200 that can be performed before or after or simultaneously with producing the self-supporting magnet coil 2 and fabricates the two magnet coil halves 4, 5, in particular in the embodiment described supra integrally in one piece from yoke parts 15, 16, arms 11, 12 and pole shoes 14, 15.

A step 400 performed subsequent to the steps 200 and 300 inserts the two yoke parts 15, 16 of the two magnet core halves 4, 5 into the pass through opening 7 of the magnet coil 2 and connects the two yoke parts with the fasteners 6, e.g. by threaded bolts.

Then it suffices for assembling or disassembling the two magnet core halves 4, 5 and the magnet coil 2 to apply or to remove the fasteners 6.

The two rigid magnets 1 of the rigid magnet rail brake device are lowered to the railheads of the rails by the lifting device in order to perform the braking until the pole shoes 14, 15 of the magnet core halves 4, 5 contact the railheads and the coil winding of the magnet coils 2 are provided with current so that the current in the magnet cores 3 respectively generates a magnetic flux which is closed by the railheads. Therefore the pole shoes 14, 15 are pulled onto the railheads by a force proportional to the magnetic flux and pressed against the railhead. The frictional engagement between the pole shoes 14, 15 and the railheads generates the brake force which is imparted onto the bogie by drive links.

### REFERENCE NUMERALS AND DESIGNATIONS

1 rigid magnet
2 magnet coil
3 magnet core
4 first magnet core half
5 second magnet core half
6 fastener
7 pass through opening
8 yoke
9 upper branch
10 lower branch
11 first arm
12 second arm
13 first pole shoe
14 second pole shoe
15 first yoke part
16 second yoke part
17 symmetry plane
18 electrical connection
19 transition section
100 step
200 step
300 step
400 step

What is claimed is:

1. A brake magnet of an electromagnetic rail brake device of a rail vehicle, the brake magnet comprising:
a magnet coil including windings of a conductive coil wire wound about a longitudinal direction of the brake magnet, so that a pass-through opening is formed transversal to the longitudinal direction;
a magnet core that includes a yoke that extends through the pass-through opening of the magnet coil and that is enveloped by an upper branch and a lower branch of the magnet coil;
and two pole shoes arranged at respective ends of the magnet core and configured to come in friction contact with a rail head of a rail,
wherein the magnet core includes two magnet core halves connected with each other and respectively including a yoke part of the yoke, wherein the two magnet core halves protrude into the pass-through opening of the magnet coil, and
wherein the magnet coil is configured form stable and/or self-supporting and without a magnet coil body.

2. The brake magnet according to claim 1, wherein a configuration of the magnet coil as a form stable and/or self-supporting magnet coil without a magnet coil body is at least partially implemented in that the windings of the coil wire are adhesively connected with one another by a medium.

3. The brake magnet according to claim 2, wherein the medium includes a glue that glues the windings of the coil wire together, and/or a curable material, wherein the windings of the coil wire are embedded in or incased by the curable material.

4. The brake magnet according to claim 1, wherein a configuration of the magnet coil as a form stable and/or self-supporting magnet coil without a magnet coil body is at least partially provided in that the windings of the coil wire are braided together to form a structure.

5. The brake magnet according to claim 1, wherein a configuration of the magnet coil as a form stable and/or self-supporting magnet coil without a magnet coil body is at least partially provided in that at least some windings of the magnet coil are windings made from an electrically conductive coil material.

6. The brake magnet according to claim 1, wherein the pole shoes of the magnet core halves are respectively integrally provided with the magnet core halves.

7. The brake magnet according to claim 1, wherein electrical connections of the magnet coil are integrally formed at the form stable and/or self-supporting magnet coil without magnet coil body.

8. The brake magnet according to claim 1, wherein the magnet core halves are exclusively connected with one another in that the yoke parts of the magnet core halves are connected with one another in the pass through opening.

9. A method for producing a brake magnet of an electromagnetic rail brake device of a rail vehicle, the brake magnet including:
a magnet coil including windings of an electrically conductive coil wire wound about a longitudinal direction of the brake magnet, so that a pass-through opening is formed transversal to the longitudinal direction,
a magnet core that includes a yoke that extends through the pass-through opening of the magnet coil and that is enveloped by an upper branch and a lower branch of the magnet coil,
and two pole shoes arranged at respective ends of the magnet core and configured to come in friction contact with a rail head of a rail, wherein the magnet core includes two magnet core halves connected with each other and respectively including yoke parts that protrude into the pass-through opening of the magnet coil and are advantageously connected with one another therein,
the method comprising:
producing the magnet coil as a form stable and/or self-supporting magnet coil without a magnet coil body;
producing the two magnet core halves;
inserting the two yoke parts of the two magnet core halves into the pass-through opening of the magnet coil; and
connecting the two magnet core halves at their yoke parts.

10. The method according to claim 9, wherein producing the magnet coil as the form stable and/or self-supporting magnet coil without magnet core body includes:
winding windings of the coil wire onto a mandrel whose outer contour essentially corresponds to an inner contour of the pass-through opening of the magnet coil, thereafter
providing a medium to the windings wound onto the mandrel, wherein the medium connects the windings through adhesion, and
removing the mandrel from the pass through opening of the magnet coil after connecting the windings by adhesion.

11. The method according to claim 9, wherein producing the magnet coil as a form stable and/or self-supporting magnet coil without a magnet coil body includes casting the windings of the magnet coil from an electrically conductive coil material and casting the magnet coil by heating the electrically conductive coil material for casting and solidifying the electrically conductive coil material after the casting to form a desired magnet coil shape.

12. The method according to claim 9, wherein the configuration of the magnet coil as the form stable and/or self-supporting magnet coil without a magnet coil body is at least partially implemented in that the windings of the coil wire are braided with one another to form a structure.

13. The method according to claim 9 wherein two magnet core halves are exclusively connected with one another by connecting the two yoke parts.

14. The method according to claim 9, wherein producing the form stable and/or self-supporting magnet coil without a magnet coil body includes integrally forming electrical connectors at the magnet coil.

15. The method according to claim 9, wherein producing the two magnet core halves includes integrally producing the two magnet core halves with the pole shoes, so that the pole shoes are integrally configured in one piece with the magnet core halves.

16. An electromagnetic rail brake device of a rail vehicle, the electromagnetic rail brake device including at least one brake magnet according to claim 1.

17. The electromagnetic rail brake device according to claim 16, wherein the brake magnet is attached at a lifting device that is configured to arrange the brake magnet vertically and transmit brake forces and transversal forces from the brake magnet through drive links.

18. A rail vehicle, comprising: the electromagnetic rail brake device according to claim 17.

19. The brake magnet according to claim 1, wherein the magnet core is horse shoe shaped in cross section.
